(19) United States
(12) Patent Application Publication
(10) Pub. No.: US 2008/0234131 A1
(43) Pub. Date: Sep. 25, 2008

(54) Herbicidal Mixtures of Cinmethylin

(76) Inventors: Markus Gewehr, Kastellaun (DE); Michael Heinz, Neustadt/W (DE); Robert Reinhard, Limburgerhof (DE)

Correspondence Address: BRINKS, HOFER, GILSON & LIONE, 2801 SLATER ROAD, SUITE 120, MORRISVILLE, NC, 27560, US

(21) Appl. No.: 12/064,497

(22) PCT Filed: Aug. 10, 2006
(86) PCT No.: PCT/EP2006/065209

§ 371 Date: Feb. 28, 2008

Related U.S. Application Data
(60) Provisional application No. 60/710,605, filed on Aug. 24, 2005.

(51) Int. Cl. A01N 43/16; A01P 13/02

(52) U.S. Cl. 504/140

(57) ABSTRACT

A herbicidal mixture comprising A) exo(+)-1 -methyl-4-(1-methylethyl)-2-[(2-methylphenyl)methoxy]-7-oxabicyclo[2.2.1]heptane (Common Name Cinmethylin) including its respective isomers and B) at least one herbicidal compound of the group of dinitro anilines of formula (I) in which the substituents have the following meanings R1 C₁-C₁₀-alkyl, C₂-C₁₀-alkenyl, C₃-C₁₀-alkinyl R2 H, C₁-C₁₀-alkyl, C₂-C₁₀-alkenyl, C₃-C₁₀-alkinyl R3, R4, R5 the same or different H, halogen, nitro, CN, C₁-C₁₀-alkyl, C₂-C₁₀-alkenyl, C₃-C₁₀-alkinyl, C₁-C₁₀-halogenalkyl, C₂-C₁₀-halogenalkenyl, C₃-C₁₀-halogenalkinyl, —SOR6, —SO₂R6, —OR7, —SR7, —N(R8)₂ R6 C₁-C₁₀-alkyl, NH₂ R7 H, C₁-C₁₀-alkyl, C₂-C₁₀-alkenyl, C₃-C₁₀-alkinyl, C₁-C₁₀-halogenalkyl C₃-C₁₀-halogenalkinyl R8 H, C₁-C₁₀-alkyl, C₂-C₁₀-alkenyl, C₃-C₁₀-alkinyl including their respective isomers as well as their respective environmentally compatible salts.

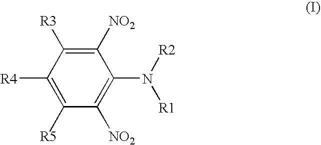

The present invention relates to a herbicidal mixture comprising
A) exo(+)-1-methyl-4-(1-methylethyl)-2-[(2-methylphenyl)methoxy]-7-oxabicyclo[2.2.1]heptane (Common Name Cinmethylin) including its respective isomers
and
B) at least one herbicidal compound of the group of dinitro anilines of formula (I)

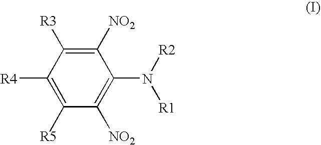

in which the substituents have the following meanings
R1 C₁-C₁₀-alkyl, C₂-C₁₀-alkenyl, C₃-C₁₀-alkinyl
R2 H, C₁-C₁₀-alkyl, C₂-C₁₀-alkenyl, C₃-C₁₀-alkinyl
R3, R4, R5 the same or different H, halogen, nitro, CN, C₁-C₁₀-alkyl, C₂-C₁₀-alkenyl, C₃-C₁₀-alkinyl, C₁-C₁₀-halogenalkyl, C₂-C₁₀-halogenalkenyl, C₃-C₁₀-halogenalkinyl, —SOR6,—SO₂R6, —OR7,—SR7,—N(R8)₂
R6 C₁-C₁₀-alkyl, NH₂
R7 H, C₁-C₁₀-alkyl, C₂-C₁₀-alkenyl, C₃-C₁₀-alkinyl, C₁-C₁₀-halogenalkyl, C₂-C₁₀-halogenalkenyl, C₃-C₁₀-halogenalkinyl
R8 H, C₁-C₁₀-alkyl, C₂-C₁₀-alkenyl, C₃-C₁₀-alkinyl
   including their respective isomers as well as their respective environmentally compatible salts.

The invention furthermore relates to herbicidal compositions comprising a herbicidally active amount of a herbicidal mixture as defined above and at least one liquid and/or solid carrier and, if desired, at least one further additive.

Moreover, the invention relates to a method of controlling undesirable vegetation by using above defined herbicidal mixture.

In crop protection products, it is always desirable to increase the specific activity and/or selectivity of an active ingredient and the reliability of action.

However, the activity and/or the selectivity of herbicides depends on a large number of factors e.g. type of the herbicide, amount of the herbicide, formulation of the herbicide, the type of weed, the combination of crop and weed, climate, soil. etc.

In many cases herbicides have an effect against a broad spectrum of weeds, however do not fight a certain type of other weeds, which is also present in the crop cultures to be protected.

Sometimes these obstacles can be overcome by using just bigger amounts of herbicide, however this is economically disadvantageous and may also reduce the selectivity of the herbicide, in other words may lead to damage of the crop to be protected.

It is a general desire in the application of agrochemicals to reduce their amount on one side and to broaden their ability to fight different weeds—which grow in certain crop cultures—without damaging the crop cultures on the other side.

This desire may be satisfied by combination of different herbicides having a different activity profile versus undesired weeds.

In some cases weeds become resistant against certain herbicides. According to current knowledge this may be due to the repeated and exclusive application of an individual herbicide. For example weeds, in particular grass weeds are reported which are tolerant or resistant against Acetyl-CoA-Carboxylase Inhibitor herbicides, such like fobs or dims (e.g. Clodinafop, Cycloxydim). For example annual ryegrass (lolium multiflorum, LOLMG) is barely faught by pendimethalin, or in other words LOLMG is virtually resistant against pendimethalin.

Therefore there is a need to develop herbicides or herbicide mixtures which do fight weeds which are tolerant or resistant to certain individual herbicides or even to certain herbicide mixtures.

Because of the huge number of herbicide active ingredients known in the art and the many factors which influence the activity and selectivity of herbicides it is virtually impossible to create the appropriate mixture just by doing some mixture experiments.

Therefore it is always a challenge to find an appropriate herbicide or herbicide mixture which fights a certain group of weeds which are tolerant or resistant to certain herbicides.

It is an object of the present invention to increase the activity and/or selectivity of herbicides against undesirable harmful plants, in particular to increase the activity and/or selectivity of herbicides against undesirable harmful plants which are resistant or tolerant against certain herbicides, in particular which are resistant or tolerant against Acetyl-CoA-Carboxylase Inhibitor herbicides, all of this without damaging the crops.

We have found that this object is achieved by the mixtures defined at the outset. We have furthermore found herbicidal compositions which comprise these mixtures, and methods of controlling undesirable vegetation.

The mixtures according to the invention show a super-additive effect; the compatibility of the herbicidally active compounds of components A) and B) for certain crop plants is generally retained.

The following active ingredients are known for example from C. D. S. Tomlin, “The Pesticide Manual”, 11^{th} Edition, BCPC (2000):

Cinmethylin, entry 153 (pages 182-183); Benfluralin, entry 61 (pages 69-70); Butralin, entry 103, (pages 123-124); Ethalfluralin, entry 289 (pages 356-357); Oryzalin, entry 576 (pages 687-688); Pendimethalin, entry 599 (pages 714-715); Trifluralin, entry 791 (pages 942-943).

The group of the dinitro anilines is further disclosed in: http://www. hclrss.demon.co.uk/index_cn_frame.html.

The common names herein shall embrace, where technically reasonable, the related a) salts, e.g. salts of alkaline or earth alkaline metals or ammonium or organoammonium salts, for instance, sodium, potassium, ammonium, isopropyl ammonium etc.; b) isomers, e.g. stereo isomers such as the respective enantiomers, in particular the respective R-or S-enantiomers (including salts, ester, amides), c) esters, e.g. carboxylic acid C1-C8-(branched or non-branched) alkyl esters, such as methylesters, ethylesters, iso propyl esters, d) amides, e.g. carboxylic acid amides or carboxylic acid C1-C8-(branched or non-branched) mono or di alkyl amides, such as dimethylamides, diethylamides, di isopropyl amides.

The compounds which are embraced by component B) are dinitro anilines expressed by the structural formula (I):

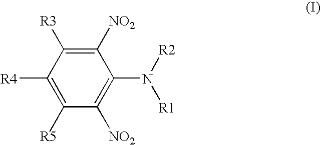

in which the substituents have the following meanings
R1 C₁-C₁₀-alkyl, C₂-C₁₀-alkenyl, C₃-C₁₀-alkinyl
R2 H, C₁-C₁₀-alkyl, C₂-C₁₀-alkenyl, C₃-C₁₀-alkinyl
R3, R4, R5 the same or different H, halogen, nitro, CN, C₁-C₁₀-alkyl, C₂-C₁₀-alkenyl, C₃-C₁₀-alkinyl, C₁-C₁₀-halogenalkyl, C₂-C₁₀-halogenalkenyl, C₃-C₁₀-halogenalkinyl, —SOR6, —SO₂R6, —OR7, —SR7, —N(R8)₂
R6 C₁-C₁₀-alkyl, NH₂
R7 H, C₁-C₁₀-alkyl, C₂-C₁₀-alkenyl, C₃-C₁₀-alkinyl, C₁-C₁₀-halogenalkyl, C₂-C₁₀-halogenalkenyl, C₃-C₁₀-halogenalkinyl
R8 H, C₁-C₁₀-alkyl, C₂-C₁₀-alkenyl, C₃-C₁₀-alkinyl
   including their respective isomers as well as their respective environmentally compatible salts.

R1 shall preferably mean C₁-C₆-alkyl, C₂-C₆-alkenyl.

R1 shall most preferably mean ethyl, n-propyl, iso-propyl, n-butyl, iso-butyl, sec-butyl, tert-butyl, n-pentyl, 3-methyl-butyl, 2-methyl-butyl, 1-methyl-butyl, 1-ethyl-propyl, vinyl, allyl, prop-1-enyl, 1-methyl-prop-2-enyl, 1-methyl-prop-1-enyl, 2-methyl-prop-1-enyl, 2-methyl-prop-2-enyl, but-1-enyl, but-2-enyl, but-3-enyl.

R2 shall preferably mean H, C₁-C₄-alkyl, C₂-C₄-alkenyl.

R2 shall most preferably mean H, methyl, ethyl, n-propyl, iso-propyl.

R3, R4, R5, the same or different shall preferably mean H, fluoro, chloro, bromo, nitro, CN, C₁-C₆-alkyl, C₂-C₆-alkenyl, C₃-C₆-alkinyl, C₁-C6-halogenalkyl, C₂-C₆-halogenalkenyl, C₃-C₆-halogenalkinyl, —SONH₂, —SO₂NH₂, —SO—C₁-C₄-alkyl, —SO₂—C₁-C₄-alkyl, —O—C₁-C₆-alkyl, —S—C₁-C₆-alkyl, —O—C₁-C₆-halogenalkyl, —S—C₁-C₆-halogenalkyl, —N(C₁-C₆-alkyl)₂, —NH—C₁-C₆-alkyl.

R3, R4, R5, the same or different shall most preferably mean H, fluoro, chloro, bromo, nitro, CN, methyl, ethyl, n-propyl, iso-propyl, vinyl, allyl, difluoromethyl, trifluoromethyl, trichloromethyl, —SONH₂, —SO₂NH₂, methoxy, ethoxy, trifluoromethoxy, difluoromethoxy, methylthio, ethylthio, trifluormethylthio, dimethylamino.

Very suitable compounds B) which can make up the mixtures with Cinmethylin are one or more of the following: Benfluralin, Butralin, Ethalfluralin, Oryzalin, Pendimethalin, Trifluralin.

In particular suitable are tic mixtures made from Cinmethylin and just one further herbicide B) from the group Benfluralin, Butralin, Ethalfluralin, Oryzalin, Pendimethalin, Trifluralin.

Very preferable mixtures are Cinmethylin plus Trifluralin or Cinmethylin plus Pendimethalin.

The present invention also extends to herbicidal compositions which comprise a herbicidally active amount of a herbicidal mixture (comprising components A) and B)), at least one liquid and/or solid carrier and, if desired, at least one further additive, for example a surfactant, adjuvant or others.

The herbicidal compositions and herbicidal mixtures according to the invention can effect very good control of grass weeds in many crops—in particular crops cultivated in Australia—without damaging the crop plants, an effect observed especially even at low rates of application.

Suitable crops are for example maize, brassica napus (canola, oilseed rape), sunflower, legumes, sugar cane, and soya, in particular cereals (for example wheat, rye).

Those weeds include but are not limited to the following plant species: Alopecurus myosuroides; Apera spica-venti; Avena spec., Lolium perenne and/or Lolium multiflorium (rye grass).

The herbicidal compositions and herbicidal mixtures according to the invention can effect very good control of undesired vegetation, preferably grass weeds for example Lolium perenne and/or Lolium multiflorium (rye grass).

In particular the herbicidal compositions and herbicidal mixtures according to the invention can effect very good control of undesired vegetation, preferably grass weeds, for example Lolium perenne and/or Lolium multiflorium (rye grass) all of those resistant or tolerant against certain herbicides, in particular resistant or tolerant against Acetyl-CoA-Carboxylase Inhibitor herbicides such as fobs or dims (e.g. Clodinafop, Cycloxydim) or even dinitro aniline herbicides, e.g. pendimethalin.

The mixtures according to the invention, or the herbicidal compositions comprising them, can be employed, for example, in the form of directly sprayable aqueous solutions, powders, suspensions, also highly-concentrated aqueous, oily or other suspensions or dispersions, emulsions, oil dispersions, pastes, dusts, materials for spreading or granules, by means of spraying, atomizing, dusting, spreading or pouring.

The use forms depend on the intended purposes; in any case, they should guarantee the finest possible distribution of the active ingredients according to the invention.

Suitable inert additives (auxiliaries) are mineral oil fractions of medium to high boiling point such as kerosene and diesel oil, furthermore coal tar oils and oils of vegetable or animal origin, aliphatic, cyclic and aromatic hydrocarbons, e.g. paraffins, tetrahydronaphthalene, alkylated naphthalenes and their derivatives, alkylated benzenes and their derivatives, alcohols such as methanol, ethanol, propanol, butanol and cyclohexanol, ketones such as cyclohexanone, strongly polar solvents, such as N-methylpyrrolidone and water.

Aqueous use forms can be prepared from emulsion concentrates, suspensions, pastes, wettable powders or water-dispersible granules by adding water. To prepare emulsions, pastes or oil dispersions, the substances, as such or dissolved in an oil or solvent, can be homogenized in water by means of wetting agent, tackifier, dispersant or emulsifier. However, it is also possible to prepare concentrates composed of active substance, wetting agent, tackifier, dispersant or emulsifier and, if appropriate, solvent or oil, and these concentrates are suitable for dilution with water.

Suitable surfactants are the alkali metal, alkaline earth metal and ammonium salts of aromatic sulfonic acids, e.g. ligno-, phenol-, naphthalene- and dibutylnaphthalenesulfonic acid, and of fatty acids, of alkyl- and alkylaryl sulfonates, of alkyl sulfates, lauryl ether sulfates and fatty alcohol sulfates, and salts of sulfated hexa-, hepta- and octadecanols, and of fatty alcohol glycol ether, condensates of sulfonated naphthalene and its derivatives with formaldehyde, condensates of naphthalene, or of the naphthalenesulfonic acids, with phenol and formaldehyde, polyoxyethylene octylphenyl ether, ethoxylated isooctyl-, octyl- or nonylphenol, alkylphenyl and tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignin-sulfite waste liquors or methylcellulose.

Powders, materials for spreading and dusts can be prepared by mixing or concomitantly grinding the herbicidal mixture or the individual active ingredients with a solid carrier.

Granules, e.g. coated granules, impregnated granules and homogeneous granules, can be prepared by binding the active ingredients to solid carriers. Solid carriers are mineral earths such as silicas, silica gels, silicates, talc, kaolin, limestone, lime, chalk, bole, loess, clay, dolomite, diatomaceous earth, calcium sulfate, magnesium sulfate, magnesium oxide, ground synthetic material, fertilizers such as ammonium sulfate, ammonium phosphate, ammonium nitrate, ureas and products of vegetable origin such as cereal meal, tree bark meal, wood meal and nutshell meal, cellulose powders or other solid carriers.

The concentrations of the mixtures according to the invention in the ready-to-use products can be varied within wide ranges. In general, the formulations comprise from 0.01 to 95% by weight, preferably 0.5 to 90% by weight, of the mixture according to the invention.

The components A) and B) can be formulated jointly, but also separately, and/or applied to the plants, their environment and/or seeds jointly or separately. It is preferable to apply the active ingredients simultaneously. However, it is also possible to apply them separately.

The components A) and B) can be applied as “pre-mix” or as “tank-mix”.

Moreover, it may be advantageous to apply the herbicidal compositions and herbicidal mixtures according to the invention, jointly or separately, with additional other crop protection agents, for example with pesticides or agents for controlling phytopathogenic fungi or bacteria. Also of interest is the miscibility with mineral salt solutions which are employed for treating nutritional and trace element deficiencies. Non-phytotoxic oils and oil concentrates can also be added.

The mixtures according to the invention and the herbicidal compositions can be applied pre- or post-emergence. It is advantageous to apply the mixtures according to the invention post emergent when the crop has in general 1 to 6 leaves.

If the active ingredients are less well tolerated by certain crop plants, application techniques may be used in which the herbicidal compositions are sprayed, with the aid of the spray apparatus, in such a way that they come into as little contact, if any, with the leaves of the sensitive crop plants while reaching the leaves of undesirable plants which grow underneath, or the bare soil (post-directed, lay-by).

In the case of a post-emergence treatment of the plants, the herbicidal mixtures or compositions according to the invention are preferably applied by foliar application. Application may be effected, for example, by usual spraying techniques with water as the carrier, using amounts of spray mixture of approx.15 to 1000l/ha. The mixtures or compositions may also be applied by the so-called “low-volume” and “ultra-low-volume” methods, or in the form of so-called granules.

The ratios of component A) and B) in the mixture in general range from 1:0.001 to 1:500, preferably from 1:0.01 to 1:100, particularly preferably from 1:0.1 to 1:50.

The rate of application of pure herbicidal mixture, i.e. without formulation auxiliaries, amounts in general to 0.1 to 5000 g/ha, preferably 1 to 3000 g/ha, in particular 5 to 2500 g/ha, of active substance (a.s.), depending on the intended aim, the season, the target plants and growth stage.

The rate of application of the component A) is usually 5 to 2500 g/ha of active substance (a.s.).

The rate of application of component or components B) is usually 0.1 to 5000 g/ha, as a rule 1 to 4000 g/ha, preferably 5 to 3000 g/ha, of active substance (a.s.).

### EXAMPLES

The mixtures according to the invention are applied pre-emergence as tank-mix which is incorporated into the soil. The herbicidal compounds of component A) and B) are applied in the formulation in which they are present as commercially available product.

Damage by the herbicidal compositions is evaluated with reference to a scale of 0% to 100% in comparison with untreated control plots. 0 means no damage and 100 means complete destruction of the plants.

For comparison the synergistic effect is estimated as follows:

The value E at which only an additive effect of the individual active ingredients is to be expected is calculated by the method of S. R. Colby (Calculating synergistic and antagonistic responses of herbicide combinations, Weeds 15, 20 pp (1967)).

This is done using the formula

$$E = X + Y - \frac{XY}{100}$$

where
X=Percentage of the herbicidal action of component A) at an application rate of a;
Y=Percentage of the herbicidal action of component B) at an application rate of b;
E=expected herbicidal action of component A)+B) at rates of application a+b (in %).

If the value observed exceeds the value E calculated in accordance with Colby's formula, then synergism is present.

The trials and their results are reported in the following table

TABLE 1
Biological results of mixtures of cinmethylin (CINCH ®)
with pendimethalin in comparison to solo applications

| | | | Cinmethylin |
|---|---|---|---|
| | | | 400 g/ha + |
| | Cinmethylin | Pendimethalin | Pendimethalin |
| Active ingredient(s): | 400 g/ha | 600 g/ha | 600 g/ha |
| % control of LOLMG: | 67 | 56 | 80 [1] |

[1] Calculated value according to Colby: 85.5

TABLE 2
Biological results of mixtures of cinmethylin (CINCH ®)
with trifuralin in comparison to solo applications

| | | | Cinmethylin |
|---|---|---|---|
| | | | 200 g/ha + |
| | Cinmethylin | Trifluralin | Trifluralin |
| Active ingredient(s): | 200 g/ha | 500 g/ha | 500 g/ha |
| % control of LOLMG: | 58 | 59 | 78 [2] |

[2] Calculated value according to Colby: 83.2

The herbicidal mixtures according to the invention exert a greater herbicidal action (close to a synergistic effect according to Colby) than would have been expected from the additive herbicidal action of the individual components.

1-10. (canceled)

11. A herbicidal mixture comprising
A) exo(+)-1-methyl-4-(1-methylethyl)-2-[(2-methylphenyl)methoxy]-7-oxabicyclo[2.2.1]heptane (Common Name Cinmethylin), isomers thereof, or mixtures thereof,
and
B) at least one herbicidal compound of the group of dinitro anilines of formula (I) 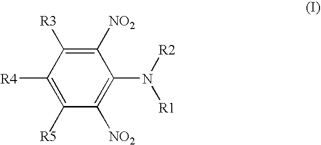
wherein
R1 is C₁-C₁₀-alkyl, C₂-C₁₀-alkenyl, or C₃-C₁₀-alkinyl;
R2 is H, C₁-C₁₀-alkyl, C₂-C₁₀-alkenyl, or C₃-C₁₀-alkinyl;
R3, R4, R5 are the same or different H, halogen, nitro, CN, C₁-C₁₀-alkyl,
C₂-C₁₀-alkenyl, C₃-C₁₀-alkinyl, C₁-C₁₀-halogenalkyl,
C₂-C₁₀-halogenalkenyl, C₃-C₁₀-halogenalkinyl, —SOR6, —SO₂R6, —OR7, —SR7, or —N(R8)₂;
R6 is C₁-C₁₀-alkyl, or NH₂;
R7 is H, C₁-C₁₀-alkyl, C₂-C₁₀-alkenyl, C₃-C₁₀-alkinyl, C₁-C₁₀-halogenalkyl, C₂-C₁₀-halogenalkenyl, or C₃-C₁₀-halogenalkinyl;
R8 is H, C₁-C₁₀-alkyl, C₂-C₁₀-alkenyl, or C₃-C₁₀-alkinyl;
isomers thereof or environmentally compatible salts thereof.

12. The herbicidal mixture of claim 11, wherein component B) is at least one member of the group of Trifluralin, Pendimethalin, Ethalfluralin, Oryzalin, Benfluralin, Butralin, their respective isomers or their respective environmentally compatible salts.

13. The herbicidal mixture of claim 11, wherein component B) is one member of the group of Trifluralin, Pendimethalin, Ethalfluralin, Oryzalin, Benfluralin Butralin, their respective isomers, or their respective environmentally compatible salts.

14. The herbicidal mixture of claim 11, wherein component B) is Trifluralin (2,6-dinitro-N,N-dipropyl-4-(trifluormethyl)benzenamine) and/or Pendimethalin (N-(1-ethylpropyl)-3,4-dimethyl-2,6-dinitrobenzenamine), their respective isomers or their respective environmentally compatible salts.

15. An herbicidal composition comprising a herbicidally active amount of a herbicidal mixture comprising:
A) exo(+)-1-methyl-4-( 1-methylethyl)-2-[(2-methylphenyl)methoxy]-7-oxabicyclo[2.2.1]heptane (Common Name Cinmethylin), isomers thereof, or mixtures thereof,
and
B) at least one herbicidal compound of the group of dinitro anilines of formula (I) 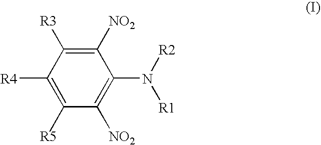
wherein
R1 is C₁-C₁₀-alkyl, C₂-C₁₀-alkenyl, or C₃-C₁₀-alkinyl;
R2 is H, C₁-C₁₀-alkyl, C₂-C₁₀-alkenyl, or C₃-C₁₀-alkinyl;
R3, R4, R5 are the same or different H, halogen, nitro, CN, C₁-C₁₀-alkyl,
C₂-C₁₀-alkenyl, C₃-C ₁₀-alkinyl, C₁-C₁₀-halogenalkyl, C₂-C₁₀-halogenalkenyl, C₃-C₁₀-halogenalkinyl, —SOR6, —SO₂R6, —OR7, —SR7, or —N(R8)₂;
R6 is C₁-C₁₀-alkyl, or NH₂;
R7 is H, C₁-C₁₀-alkyl, C₂-C₁₀-alkenyl, C₃-C₁₀-alkinyl, C₁-C₁₀-halogenalkyl, C₂-C₁₀-halogenalkenyl, or C₃-C₁₀-halogenalkinyl;
R8 is H, C₁-C₁₀-alkyl, C₂-C₁₀-alkenyl, or C₃-C₁₀-alkinyl;
isomers thereof or environmentally compatible salts thereof;
at least one inert liquid and/or solid carrier and, optionally, at least one further additive.

16. A method of controlling undesired vegetation, which comprises applying a herbicidal mixture comprising
A) exo(+)-1-methyl-4-(1-methylethyl)-2-[(2-methylphenyl)methoxy]-7-oxabicyclo[2.2.1]heptane (Common Name Cinmethylin), isomers thereof, or mixtures thereof;
and
B) at least one herbicidal compound of the group of dinitro anilines of formula (I) 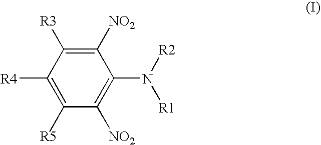
wherein
R1 is C₁-C₁₀-alkyl, C₂-C₁₀-alkenyl, or C₃-C₁₀-alkinyl;
R2 is H, C₁-C₁₀-alkyl, C₂-C₁₀-alkenyl, or C₃-C₁₀-alkinyl;
R3, R4, R5 are the same or different H, halogen, nitro, CN, C₁-C₁₀-alkyl,
C₂-C₁₀-alkenyl, C₃-C₁₀-alkinyl, C₁-C₁₀-halogenalkyl, C₂-C₁₀-halogenalkenyl, C₃-C₁₀-halogenalkinyl, —SOR6, —SO₂R6, —OR7, —SR7, or —N(R8)₂;
R6 is C₁-C₁₀-alkyl, or NH₂;
R7 is H, C₁-C₁₀-alkyl, C₂-C₁₀-alkenyl, C₃-C₁₀-alkinyl, C₁-C₁₀-halogenalkyl, C₂-C₁₀-halogenalkenyl, or C₃-C₁₀-halogenalkinyl;
R8 is H, C₁-C₁₀-alkyl, C₂-C₁₀-alkenyl, or C₃-C₁₀-alkinyl;
isomers thereof or environmentally compatible salts thereof, wherein
the mixture is applied before, during and/or after the emergence of undesired plants, simultaneously or in succession.

17. The method of controlling undesired vegetation of claim 16, wherein the undesired plants are grass weeds.

18. The method of controlling undesired vegetation of claim 16, wherein the undesired plants are Lolium perenne and/or Lolium multiflorum (rye grass) grass weeds.

19. The method of claim 16, wherein the undesired plants are tolerant or resistant against Acetyl-CoA-Carboxylase Inhibitor herbicides and/or dinitroaniline herbicides.

20. The method of claim 18, wherein the Lolium perenne and/or Lolium multiflorum (rye grass) grass weeds are tolerant or resistant against dinitroaniline herbicides.
